(19) United States
(12) Patent Application Publication
(10) Pub. No.: US 2024/0020279 A1
(43) Pub. Date: Jan. 18, 2024

(54) SYSTEMS AND METHODS FOR INTELLIGENT DATABASE RECOMMENDATION

(71) Applicant: Dell Products L.P., Round Rock, TX (US)

(72) Inventors: Dhilip Kumar, Bangalore (IN); Bijan Kumar Mohanty, Austin, TX (US); Ponnayan Sekar, Attibele (IN); Hung Dinh, Austin, TX (US)

(73) Assignee: Dell Products L.P., Round Rock, TX (US)

(21) Appl. No.: 17/813,137

(22) Filed: Jul. 18, 2022

(51) Int. Cl. G06F 16/21; G06F 11/34

(52) U.S. Cl. CPC G06F 16/211; G06F 11/3452

(57) ABSTRACT

In one aspect, an example methodology implementing the disclosed techniques includes, by a computing device, receiving a set of requirements for a database and generating a feature vector representative of the set of requirements for the database. The method also includes, by the computing device, predicting, using a machine learning (ML) model, a database for the set of requirements based on the feature vector and sending information indicative of the predicted database to a client. The predicted database may be a database that is optimal for the received set of requirements. The ML model may be a multiclass classification model.

### BACKGROUND

Organizations, such as companies and enterprises, often utilize databases for management of their data. Different types of databases are available which are usually optimized for performing certain types of database queries. For example, relational databases, such as MySQL, SQL Server, Oracle database, PostgreSQL, and Microsoft SQL Server, are optimized for writes, but not reads. These relational databases traditionally feature strong consistency and high availability. Conversely, non-relational databases, such as key-value databases, document-oriented databases (e.g., MongoDB), column-oriented databases (e.g., Apache Cassandra), and graph databases (e.g., Neo4J and Gremlin), are optimized for reads, but not writes. These non-relational databases are traditionally developed to service availability and partition tolerance, or consistency and partition tolerance needs. Due to the trade-offs between the different types of databases, most organizations typically employ a heterogenous approach which includes use of different types of databases.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving a set of requirements for a database and generating a feature vector representative of the set of requirements for the database. The method also includes, by the computing device, predicting, using a machine learning (ML) model, a database for the set of requirements based on the feature vector and sending information indicative of the predicted database to a client.

In some embodiments, the ML model includes a multiclass classification model.

In some embodiments, the ML model is trained using a modeling dataset generated from a corpus of historical database transaction metadata and database attribute metadata of an organization.

In some embodiments, the corpus of database transaction metadata includes information indicative of database transactions of the organization and corresponding performance metrics.

In some embodiments, the corpus of database attribute metadata includes information indicative of types of databases utilized by the organization.

In some embodiments, the corpus of database attribute metadata includes information indicative of features provided by databases utilized by the organization.

In some embodiments, the corpus of database attribute metadata includes information indicative of availability provided by databases utilized by the organization.

In some embodiments, the corpus of database attribute metadata includes information indicative of transaction level capabilities of databases utilized by the organization.

In some embodiments, the corpus of database attribute metadata includes information indicative of security and access control capabilities of databases utilized by the organization.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1A is a block diagram of an illustrative network environment for intelligent database recommendation, in accordance with an embodiment of the present disclosure.

FIG. 1B is a block diagram of an illustrative database selection service, in accordance with an embodiment of the present disclosure.

FIG. 2 shows an illustrative workflow for a model building process, in accordance with an embodiment of the present disclosure.

FIG. 3 is a diagram illustrating a portion of a data structure that can be used to store information about relevant features of a modeling dataset for training a machine learning (ML) model to predict a database for a particular set of requirements, in accordance with an embodiment of the present disclosure.

FIG. 4 is a diagram illustrating an example architecture of a dense neural network (DNN)-based multiclass classification model of a database selection module, in accordance with an embodiment of the present disclosure.

FIG. 5 is a diagram showing an example topology that can be used to predict a database for a particular set of requirements, in accordance with an embodiment of the present disclosure.

FIG. 6 is a flow diagram of an example process for recommending a database for a particular set of requirements, in accordance with an embodiment of the present disclosure.

FIG. 7 is a block diagram illustrating selective components of an example computing device in which various aspects of the disclosure may be implemented, in accordance with an embodiment of the present disclosure.

### DETAILED DESCRIPTION

Organizations often utilize databases for data storage and access in the delivery of their products such as computing applications and microservices. Choosing the right database can be one of the most important decisions an organization can make when delivering a new product. The process of choosing the right database can be more daunting for organizations that implement a heterogenous database environment. No matter how well product is designed and built, the success of the product primarily hinges on its ability to manage, retrieve, process, and deliver information in a secure and timely manner, adhering to the performance and scalability requirements set by the organization. However, the choice of the database is often one of familiarity or ad-hoc research by the product architect or developer in the organization. If the organization later realizes that it made the wrong choice, migrating the product to another database can be a very costly and risky endeavor. Choosing the wrong database can also be inefficient in terms of effort and result in increased resource usage by computing devices used to host and provide the databases for the products.

Certain embodiments of the concepts, techniques, and structures disclosed herein are directed to intelligent database recommendation for a particular set of requirements. The requirements may be for a database for a product (e.g., an application or microservice) developed or provided by an organization. In some embodiments, a deep learning algorithm such as, for example, a multilayer perceptron (MLP) or an artificial neural network (ANN), may be trained using a modeling dataset generated from the organization's historical database transaction metadata and information about the attributes of the databases utilized by the organization (e.g., attributes of the databases on which the historical database transactions are performed). The database transaction metadata may be collected from data access audit logs maintained by the various databases and include information about individual database transactions and corresponding performance metrics. For a particular database, the attributes may include information indicative of the capabilities of the database such as the type of database, features provided or supported by the database, availability provided or supported by the database, transaction level provided or supported by the database, and/or security and access control provided or supported by the database. Once the deep learning algorithm is trained, the machine learning (ML) model can, in response to input of a set of requirements for a database, predict a database that is optimal for the input set of requirements. The prediction is based on actual transactional usage data of the various databases utilized by and available to the organization. The predicted database can then be recommended for use by the organization.

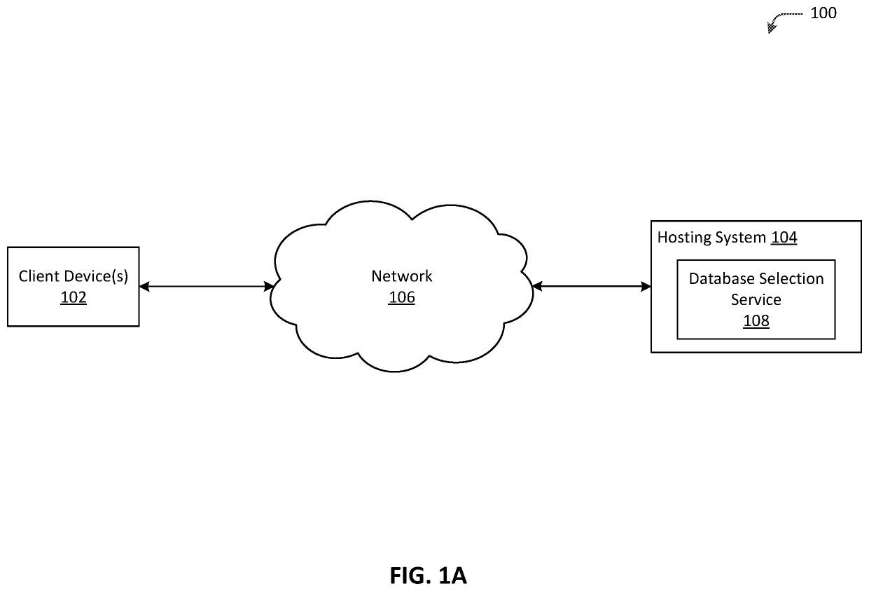

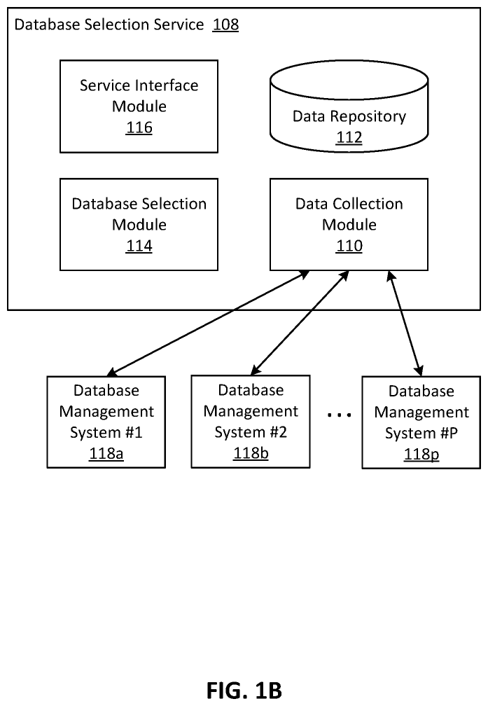

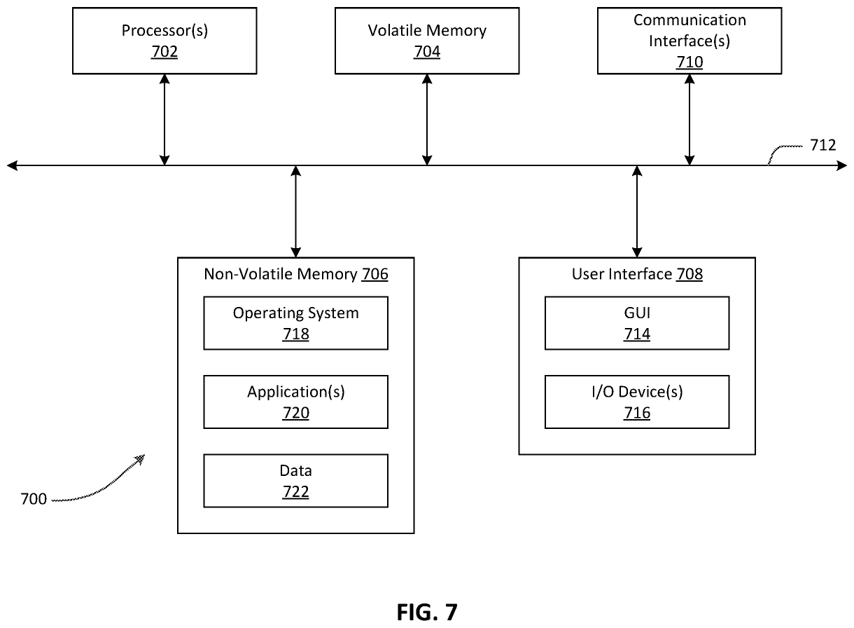

Turning now to the figures, FIG. 1A is a block diagram of an illustrative network environment 100 for intelligent database recommendation, in accordance with an embodiment of the present disclosure. As illustrated, network environment 100 may include one or more client devices 102 communicatively coupled to a hosting system 104 via a network 106. Client devices 102 can include smartphones, tablet computers, laptop computers, desktop computers, workstations, or other computing devices configured to run user applications (or “apps”). In some implementations, client devices 102 may be substantially similar to a computing device 700, which is further described below with respect to FIG. 7.

Hosting system 104 can include one or more computing devices that are configured to host and/or manage applications and/or services. Hosting system 104 may include load balancers, frontend servers, backend servers, authentication servers, and/or any other suitable type of computing device. For instance, hosting system 104 may include one or more computing devices that are substantially similar to computing device 700, which is further described below with respect to FIG. 7.

In some embodiments, hosting system 104 can be provided within a cloud computing environment, which may also be referred to as a cloud, cloud environment, cloud computing or cloud network. The cloud computing environment can provide the delivery of shared computing services (e.g., microservices) and/or resources to multiple users or tenants. For example, the shared resources and services can include, but are not limited to, networks, network bandwidth, servers, processing, memory, storage, applications, virtual machines, databases, software, hardware, analytics, and intelligence.

As shown in FIG. 1A, hosting system 104 may include a database selection service 108. As described in further detail at least with respect to FIGS. 1B-6, database selection service 108 is generally configured to recommend a database for a particular set of requirements. The recommended database may be one or the databases utilized by and available to the organization. Briefly, in one example use case, a user associated with the organization, such as a product architect or other member of an engineering team, can use a client application, such as a web client, on their client device 102 to access database selection service 108. For example, the client application may provide user interface (UI) controls that the user can click/tap/interact with to access database selection service 108 and issue a request for a database recommendation. The client application may also provide UI elements (e.g., a database requirement form) with which the user can specify a set of requirements for the database. In response to such request being received, database selection service 108 can predict a database that is optimal for the specified set of requirements and recommend the predicted database in a response to the client application. In response to receiving the response, the client application can present the response (e.g., the recommended database) within a UI (e.g., a graphical user interface) for viewing by the user. The user can then take appropriate action based on the provided recommendation. For example, the user may use the recommended database in delivering the organization's product.

FIG. 1B is a block diagram of an illustrative database selection service 108, in accordance with an embodiment of the present disclosure. For example, an organization such as a company, an enterprise, or other entity that utilizes databases in the delivery of its products, for instance, may implement and use database selection service 108 to intelligently recommend a database for a particular set of requirements. Database selection service 108 can be implemented as computer instructions executable to perform the corresponding functions disclosed herein. Database selection service 108 can be logically and/or physically organized into one or more components. The various components of database selection service 108 can communicate or otherwise interact utilizing application program interfaces (APIs), such as, for example, a Representational State Transfer (RESTful) API, a Hypertext Transfer Protocol (HTTP) API, or another suitable API, including combinations thereof.

In the example of FIG. 1B, database selection service 108 includes a data collection module 110, a data repository 112, a database selection module 114, and a service interface module 116. Database selection service 108 can include various other components (e.g., software and/or hardware components) which, for the sake of clarity, are not shown in FIG. 1B. It is also appreciated that database selection service 108 may not include certain of the components depicted in FIG. 1B. For example, in certain embodiments, database selection service 108 may not include one or more of the components illustrated in FIG. 1B, but database selection service 108 may connect or otherwise couple to the one or more components via a communication interface. Thus, it should be appreciated that numerous configurations of database selection service 108 can be implemented and the present disclosure is not intended to be limited to any particular one. That is, the degree of integration and distribution of the functional component(s) provided herein can vary greatly from one embodiment to the next, as will be appreciated in light of this disclosure.

Referring to database selection service 108, data collection module 110 is operable to collect or otherwise retrieve the organization's historical database transaction metadata from one or more database management systems 118a-118p (individually referred to herein as database management system 118 or collectively referred to herein as database management systems 118) or from other data sources that contain the historical database transaction metadata. For a particular database transaction, the transaction metadata may include information describing the particular database transaction and corresponding performance metrics such as type of operation (e.g., create, read, update, or delete (CRUD)), average latency, volume, and transaction complexity, to provide a few examples. In some embodiments, database management systems 118 may correspond to the different database systems being utilized by the organization. Non-limiting examples of the organization's database management systems 118 include relational database systems such as MySQL, PostgreSQL, Microsoft SQL, and Oracle DB, non-relational database systems such as MongoDB and Apache Cassandra, graph database systems such as Neo4J and Gremlin, online analytical processing (OLAP) database systems such as Teradata, Greenplum, and OracleTer, online transaction processing (OLTP) database systems, and hybrid database systems, including various versions of such database systems. The individual database management systems 118 may maintain the database transaction metadata in data access audit logs. A particular data source (e.g., database management system 118) can be hosted within a cloud computing environment or within an on-premise data center (e.g., an on-premise data center of the organization that utilizes database selection service 108).

Data collection module 110 is also operable to collect or otherwise retrieve information about the attributes (or “capabilities”) of database management systems 118. Such information is referred to herein as “database attribute metadata.” Data collection module 110 may collect the database attribute metadata from the different database management systems 118 or from one or more other data sources that contain the database attribute metadata. For a particular database management system 118, the database attribute metadata may include information about the type of database (e.g., relational or non-relational; document, row, or columnar; in memory or disk; transactional or analytical; structured or unstructured; schema or schemeless; data types; etc.), information about the features provided or supported by the database (e.g., index (primary/secondary); inbuild pipeline connection; functions; extended scripts; functions and/or stored procedures; database connection; connection pool; etc.), availability provided or supported by the database (e.g., active/disaster recovery; active geo-replication; availability zones; regional access; consistency level; partition levels; cross data centers; etc.), transaction level capabilities of the database (e.g., read/write transaction; bulk data loads; streaming transaction; transactions per second (TPS) throughput; read throughput; search-index; cross node reads; etc.), and/or security and access control capabilities of the database (e.g., encryption levels; connection levels; role-based access control; data classification; transport level security; password/key-based access; node detection; etc.).

Data collection module 110 can utilize application programming interfaces (APIs) provided by the various data sources to collect information and materials therefrom. For example, data collection module 110 can use a REST-based API, DataBase API (DB-API), or other suitable API provided by a database management system to collect information therefrom (e.g., to collect the historical database transaction metadata and database attribute metadata). As another example, data collection module 110 can use a file system interface to retrieve the files/documents containing the data access audit logs, database attribute information, etc., from a file system.

In cases where a database management system or a data source does not provide an interface or API, other means, such as printing and/or imaging, may be utilized to collect information therefrom (e.g., generate an image of printed file/document containing a data access audit log(s) and/or database attribute information). Optical character recognition (OCR) technology can then be used to convert the image of the content to textual data.

In some embodiments, data collection module 110 can collect information/data from one or more of the various data sources on a continuous or periodic basis (e.g., according to a predetermined schedule specified by the organization). Additionally or alternatively, data collection module 110 can collect information/data from one or more of the various data sources in response to an input. For example, a user, such as a product architect or other member of the organization, can use their client device 102 to access database selection service 108 can issue a request to retrieve information about a historical order(s) and their fulfillment and customer information form one or more data sources to database selection service 108. In some embodiments, data collection module 110 can store the information and materials collected from the various data sources within data repository 112, where it can subsequently be retrieved and used. For example, information and materials from data repository 112 can be retrieved and used to generate a modeling dataset for use in generating a ML model. In some embodiments, data repository 112 may correspond to a storage service within the computing environment of database selection service 108.

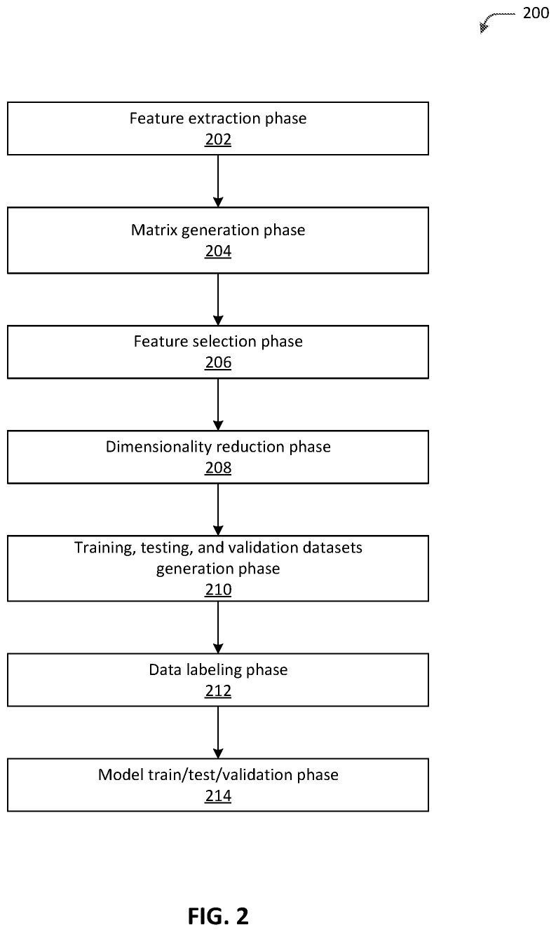

Still referring to database selection service 108, database selection module 114 is operable to predict a database for a particular set of requirements. In other words, database selection module 114 is operable to predict, for a specified set of requirements for a database, a database that is optimal for the specified requirements. The predicted database may be a database that is utilized by and available to the organization. To this end, in some embodiments, database selection module 114 can include a deep learning algorithm, such as a multilayer perception (MLP) or an artificial neural network (ANN), that is trained and tested using machine learning techniques with a modeling dataset generated from the organization's historical database transaction metadata and the database attribute metadata. For example, the historical database transaction metadata and the database attribute metadata used to generate the modeling dataset may be collected by data collection module 110, as previously described herein. In some embodiments, the deep learning algorithm can be trained and tested using the modeling dataset to build a multiclass classification model (sometimes referred to herein more simply as a “multiclass classifier”). Once the deep learning algorithm is trained, the trained multiclass classification model can, in response to input of a particular set of requirements for a database, predict database that is optimal for the input set of requirements. Further description of the deep learning algorithm(s) and other processing that can be implemented within database selection module 114 is provided below at least with respect to FIGS. 2-4.

Service interface module 116 is operable to provide an interface to database selection service 108. For example, in one embodiment, service interface module 116 may include an API that can be utilized, for example, by client applications to communicate with database selection service 108. For example, a client application, such as a web client, on a client device (e.g., client device 102 of FIG. 1A) can send requests (or “messages”) to database selection service 108 wherein the requests are received and processed by service interface module 116. Likewise, database selection service 108 can utilize service interface module 116 to send responses/messages to the client application on the client device.

In some embodiments, service interface module 116 may include user interface (UI) controls/elements which may be presented on a UI of the client application on the client device and utilized to access database selection service 108. For example, a user can click/tap/interact with the presented UI controls/elements to specify a set of requirements for a database and send a request for a database recommendation for the specified set of requirements. In response to the user's input, the client application on the client device may send a request to database selection service 108 for a database recommendation for the specified set of requirements. In response to the request from the client application, database selection service 108 can utilize database selection module 114 to predict a database that is optimal for the specified set of requirements. Database selection service 108 can then send the predicted database (e.g., information indicative of the predicted database) to the client application as a recommended database for the set of requirements specified by the user.

Referring now to FIG. 2 and with continued reference to FIGS. 1A and 1B, shown is an illustrative workflow 200 for a model building process, in accordance with an embodiment of the present disclosure. In particular, workflow 200 is an illustrative process for building (or “providing”) a multiclass classification model (e.g., an MLP or an ANN) for database selection module 114. As shown, workflow 200 includes a feature extraction phase 202, a matrix generation phase 204, a feature selection phase 206, a dimensionality reduction phase 208, a modeling dataset generation phase 210, a data labeling phase 212, and a model train/test/validation phase 214.

In more detail, feature extraction phase 202 can include extracting features from a corpus of historical database transaction metadata and attributes of the organization's databases. The historical database transaction metadata and attributes of the organization's databases, i.e., the database attribute metadata, from which to extract the features may be retrieved from data repository 112. In some embodiments, the historical transaction metadata and the database attribute metadata may cover database transactions to any one of the databases that are utilized by the organization. In other embodiments, the historical transaction metadata and the database attribute metadata may cover database transactions to any one of a subset of the databases that are utilized by the organization (e.g., cover database transactions to the databases that the organization will continue to utilize). The features may be extracted per historical database transaction (e.g., features may be extracted per CRUD operation). In one embodiment, the features may be extracted from one, two, or more years of historical database transaction metadata and database attribute metadata. The amount of historical database transaction metadata and database attribute metadata from which to extract the features may be configurable by the organization.

Matrix generation phase 204 can include placing the features extracted from the historical database transaction metadata and database attribute metadata in a matrix. In the matrix, the structured columns represent the features (also called “variables”) and each row represents an observation or instance (e.g., a historical database transaction). Thus, each column in the table shows a different feature of the instance.

Feature selection phase 206 can include dropping the features with no relevance to the outcome (e.g., removing the features that are not correlated to the thing being predicted). For example, a variety of feature engineering techniques, such as exploratory data analysis (EDA) and/or bivariate data analysis with multivariate-variate plots and/or correlation heatmaps and diagrams, among others, may be used to determine the relevant or important features from the noisy data and the features with no relevance to the outcome (e.g., prediction of a database). The relevant features are the features that are more correlated with the thing being predicted by the trained model. The noisy data and the features with no relevance to the outcome can then be removed from the matrix.

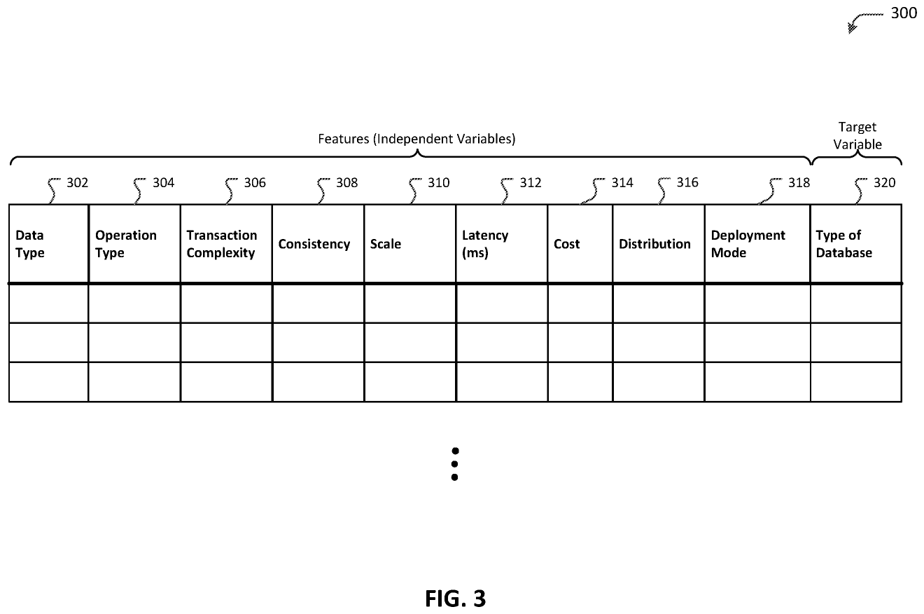

Dimensionality reduction phase 208 can include reducing the number of features in the dataset (e.g., reduce the number of features in the matrix). For example, since the modeling dataset is being generated from the corpus of historical database transaction metadata and attributes of the organization's databases, the number of features (or input variables) in the dataset may be very large. The large number of input features can result in poor performance for machine learning algorithms. For example, in one embodiment, dimensionality reduction techniques, such as principal component analysis (PCA), may be utilized to reduce the dimension of the modeling dataset (e.g., reduce the number of features in the matrix), hence improving the model's accuracy and performance. Examples of relevant features of a modeling dataset for the multiclass classification model for database selection module 114 is provided below with respect to FIG. 3.

Training, testing, and validation datasets generation phase 210 can include splitting the modeling dataset into a training dataset, a testing dataset, and a validation dataset. The modeling dataset may be comprised of the individual instances (i.e., the individual historical database transactions) in the matrix. The modeling dataset can be separated into two (2) groups: one for training the multiclass classification model and the other for testing and validating (or “evaluating”) the multiclass classification model. For example, based on the size of the modeling dataset, approximately 70% of the modeling dataset can be designated for training the multiclass classification model and the remaining portion (approximately 30%) of the modeling dataset can be designated for testing and validating the multiclass classification model.

Data labeling phase 212 can include adding an informative label to each instance in the modeling dataset. As explained above, each instance in the modeling dataset is a historical database transaction. A label (e.g., an indication of a database) is added to each instance in the modeling dataset. The label added to each instance, i.e., each historical database transaction, is a representation of what class of objects the instance in the modeling dataset belongs to and helps a machine learning model learn to identify that particular class when encountered in data without a label. For example, for a particular historical database transaction, the added label may indicate a database on which the historical database transaction was performed.

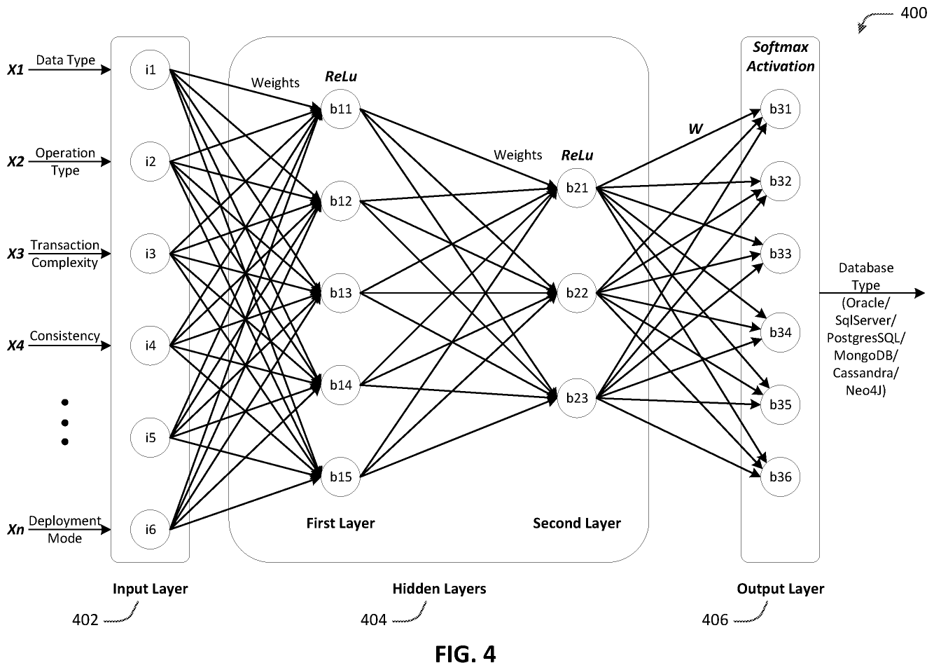

Model train/test/validation phase 214 can include training and testing/validating the multiclass classification model using the modeling dataset. Once the multiclass classification model is sufficiently trained and tested/validated, the model can, in response to input of a set of requirements for a database, predict a database that is optimal for the input set of requirements. Further description of training and testing the multiclass classification model is provided below at least with respect to FIG. 4.

In brief, the model can then be trained by passing the portion of the modeling dataset designated for training (i.e., the training dataset) and specifying a number of epochs. An epoch (one pass of the entire training dataset) is completed once all the observations of the training data are passed through the model. The model can be validated using the portion of the modeling dataset designated for testing and validating (i.e., the testing dataset and the validation dataset) once the model completes a specified number of epochs. For example, the model can process the training dataset and a loss value (or “residuals”) can be computed and used to assess the performance of the model. The loss value indicates how well the model is trained. Note that a higher loss value means the model is not sufficiently trained. In this case, hyperparameter tuning may be performed by changing a loss function, changing an optimizer algorithm, or making changes to the neural network architecture by adding more hidden layers. Once the loss is reduced to a very small number (ideally close to 0), the model is sufficiently trained for prediction.

Referring now to FIG. 3 and with continued reference to FIGS. 1A and 1B, shown is a diagram illustrating a portion of a data structure 300 that can be used to store information about relevant features of a modeling dataset for training a machine learning (ML) model to predict a database for a particular set of requirements, in accordance with an embodiment of the present disclosure. As can be seen, data structure 300 may be in a tabular format in which the structured columns represent the different relevant features (variables) regarding the historical database transaction metadata and attributes of the organization's databases and a row represents individual historical database transactions. The relevant features may be extracted from the organization's historical database transactions and other metadata and attributes of the organization's various databases (e.g., metadata and attributes indicative of the capabilities of the databases such as types of databases, features provided or supported by the databases, availability provided or supported by the databases, transaction level capabilities of the databases, and security and access control capabilities of the databases). The relevant features illustrated in data structure 300 are merely examples of features that may be extracted from the historical database transaction metadata and attributes of the organization's databases and used to generate a modeling dataset and should not be construed to limit the embodiments described herein.

As shown in FIG. 3, the relevant features may include a database type 302, an operation type 304, a transaction complexity 306, a consistency 308, a scale 310, a latency 312, a cost 314, a distribution 316, a deployment mode 318, and a type of database 320. Data type 302 indicates the datatype (e.g., structured, unstructured, networked, schema, etc.) recognized by the database on which the instance, i.e., historical database transaction, was performed. Operation type 304 indicates the type of operation (e.g., CRUD) of the historical database transaction. For example, the historical database transaction may be one of a create, read, update, or delete operation. Transaction complexity 306 indicates a complexity (e.g., high, mid, low) of the historical database transaction. Consistency 308 indicates a consistency capability (e.g., strict consistency or eventual consistency) of the database on which the historical database transaction was performed. Scale 310 indicates the scalability capability (e.g., low, medium, high, very high, etc.) of the database on which the historical database transaction was performed. Scalability of a database is the ability to expand or contract the capacity of database system resources. Latency 312 indicates the total time taken to perform the historical database transaction. The total time may be indicated in milliseconds (ms). For a given historical database transaction, the total time may include the time taken to send, execute, and receive a response to the database transaction (e.g., a database CRUD query). Cost 314 indicates the cost (e.g., low, medium, high) of the database on which the historical database transaction was performed. Distribution 316 indicates the level of distribution (e.g., local, regional, global, etc.) of the database on which the historical database transaction was performed. Deployment mode 318 indicates the type of deployment (e.g., on-premise, cloud, etc.) of the database on which the historical database transaction was performed. For example, the database may be deployed within the cloud or within an on-premise data center (e.g., an on-premise data center of the organization). Type of database 320 indicates a database on which the historical database transaction was performed. Type of database 320 is the label added to the historical database transaction. In some embodiments, the database may be a database system/product, including different versions of the database system/product.

In data structure 300, each row may represent a training/testing/validation sample (i.e., an instance of a training/testing/validation sample) in the modeling dataset, and each column may show a different relevant feature of the training/testing/validation sample. In some embodiments, the individual training/testing/validation samples may be used to generate a feature vector, which is a multi-dimensional vector of elements or components that represent the features in a training/testing/validation sample. In such embodiments, the generated feature vectors may be used for training/testing/validating a ML multiclass classification model (e.g., a deep learning algorithm for building the multiclass classification model of database selection module 114) to predict a database for a particular set of requirements. The features data type 302, operation type 304, transaction complexity 306, consistency 308, scale 310, latency 312, cost 314, distribution 316, and deployment mode 318 may be included in a training/testing/validation sample as the independent variables, and the feature type of database 320 included as the dependent variable (target variable) in the training/testing/validation sample. The illustrated independent variables are features that influence performance of the ML model (i.e., features that are relevant (or influential) in predicting a database).

Referring now to FIG. 4 and with continued reference to FIGS. 1B and 3, illustrated is an example architecture of a dense neural network (DNN)-based multiclass classification model of database selection module 114, in accordance with an embodiment of the present disclosure. In brief, a DNN includes an input layer for all input variables, multiple hidden layers for feature extraction, and an output layer. Each layer may be comprised of a number of nodes or units embodying an artificial neuron (or more simply a “neuron”). As a DNN, each neuron in a layer receives an input from all the neurons in the preceding layer. In other words, every neuron in each layer is connected to every neuron in the preceding layer and the succeeding layer. As a multiclass classification model, the output layer is comprised of multiple neurons equal to the number of classes (e.g., the number of different types of databases for which a prediction is being generated). For example, the number of classes may be equal to the number of different databases utilized by the organization. Each of the neurons in the output layer may output a numerical value (e.g., a percentage value) which represents the prediction for the respective class. In other words, an output of a neuron in the output layer is a prediction for the class (e.g., the database or the type of database) represented by the neuron.

In more detail, and as shown in FIG. 4, a DNN 400 includes an input layer 402, multiple hidden layers 404 (e.g., two hidden layers), and an output layer 406. Input layer 402 may be comprised of a number of neurons to match (i.e., equal to) the number of input variables (independent variables). Taking as an example the independent variables illustrated in data structure 300 (FIG. 3), input layer 402 may include nine (9) neurons to match the nine independent variables (e.g., data type 302, operation type 304, transaction complexity 306, consistency 308, scale 310, latency 312, cost 314, distribution 316, and deployment mode 318), where each neuron in input layer 402 receives a respective independent variable. Each succeeding layer (e.g., a first layer and a second layer) in hidden layers 404 can further comprise an arbitrary number of neurons, which may depend on the number of neurons included in input layer 402. For example, according to one embodiment, the number of neurons in the first hidden layer may be determined using the relation 2ⁿ≥number of neurons in input layer, where n is the smallest integer value satisfying the relation. In other words, the number of neurons in the first layer of hidden layers 404 is the smallest power of 2 value equal to or greater than the number of neurons in input layer 302. For example, in the case where there are 19 input variables, input layer 302 will include 19 neurons. In this example case, the first layer can include 32 neurons (i.e., 2⁵=32). Each succeeding layer in hidden layers 404 may be determined by decrementing the exponent n by a value of one. For example, the second layer can include 16 neurons (i.e., 2⁴=16). In the case where there is another succeeding layer (e.g., a third layer) in hidden layers 404, the third layer can include eight (8) neurons (i.e., 2³=8). As a multiclass classification model, output layer 406 includes multiple neurons to match (i.e., equal to) the number of classes (e.g., the number of different types of databases for which a prediction is being generated). In the example of FIG. 4, output layer 406 includes six (6) neurons for the databases Oracle, SqlServer, PostgresSQL, MongoDB, Cassandra, and Neo4J, respectively.

Although FIG. 4 shows hidden layers 404 comprised of only two layers, it will be understood that hidden layers 404 may be comprised of a different number of hidden layers. Also, the number of neurons shown in the first layer and in the second layer of hidden layers 404 is for illustration only, and it will be understood that actual numbers of neurons in the first layer and in the second layer of hidden layers 404 may be based on the number of neurons in input layer 402.

Each neuron in hidden layers 404 and the neurons in output layer 406 may be associated with an activation function. For example, according to one embodiment, the activation function for the neurons in hidden layers 404 may be a rectified linear unit (ReLU) activation function. As DNN 400 is to function as a multiclass classification model, the activation functions for the neurons in output layer 406 may be softmax activation functions.

Since this is a dense neural network, as can be seen in FIG. 4, each neuron in the different layers may be coupled to one another. Each coupling (i.e., each interconnection) between two neurons may be associated with a weight, which may be learned during a learning or training phase. Each neuron may also be associated with a bias factor, which may also be learned during the training phase.

During a first pass (epoch) in the training phase, the weight and bias values may be set randomly by the neural network. For example, according to one embodiment, the weight and bias values may all be set to 1 (or 0). Each neuron may then perform a linear calculation by combining the multiplication of each input variables (x1, x2, . . . ) with their weight factors and then adding the bias of the neuron. The equation for this calculation may be as follows:

ws1=x1·w1+x2·w2+ . . . +b1,

where ws1 is the weighted sum of the neuron1, x1, x2, etc. are the input values to the model, w1, w2, etc. are the weight values applied to the connections to the neuron1, and b1 is the bias value of neuron1. This weighted sum is input to an activation function (e.g., ReLU) to compute the value of the activation function. Similarly, the weighted sum and activation function values of all the other neurons in a layer are calculated. These values are then fed to the neurons of the succeeding (next) layer. The same process is repeated in the succeeding layer neurons until the values are fed to the neuron of output layer 406. Here, the weighted sum may also be calculated and compared to the actual target value. Based on the difference, a loss value can be calculated. The loss value indicates the extent to which the model is trained (i.e., how well the model is trained). This pass through the neural network is referred to as a forward propagation, which calculates the error and drives a backpropagation through the network to minimize the loss or error at each neuron of the network. Considering the error/loss is generated by all the neurons in the network, backpropagation goes through each layer from back to forward and attempts to minimize the loss using, for example, a gradient descent-based optimization mechanism or some other optimization method. Since the neural network is used as a multiclass classifier, categorical crossentropy may be used as the loss function, adaptive movement estimation (Adam) as the optimization algorithm, and “accuracy” as the validation metric. In other embodiments, unpublished optimization algorithm designed for neural networks (RMSprop) may be used as the optimization algorithm.

The result of this backpropagation is used to adjust (update) the weight and bias values at each connection and neuron level to reduce the error/loss. An epoch (one pass of the entire training dataset) is completed once all the observations of the training data are passed through the neural network. Another forward propagation (e.g., epoch 2) may then be initiated with the adjusted weight and bias values and the same process of forward and backpropagation may be repeated in the subsequent epochs. Note that a higher loss value means the model is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train the model. In any case, once the loss is reduced to a very small number (ideally close to zero (0)), the neural network is sufficiently trained for prediction.

For example, a DNN 400 can be built by first creating a shell model and then adding a desired number of individual layers to the shell model. For each layer, the number of neurons to include in the layer can be specified along with the type of activation function to use and any kernel parameter settings. Once DNN 400 is built, a loss function (e.g., categorical crossentropy), an optimizer algorithm (e.g., Adam or a gradient-based optimization technique such as RMSprop), and validation metrics (e.g., “accuracy”) can be specified for training, validating, and testing DNN 400.

DNN 400 can then be trained by passing the portion of the modeling dataset designated for training (e.g., 70% of the modeling dataset designated as the training dataset) and specifying a number of epochs. An epoch (one pass of the entire training dataset) is completed once all the observations of the training data are passed through DNN 400. DNN 400 can be validated once DNN 400 completes the specified number of epochs. For example, DNN 400 can process the training dataset and the loss/error value can be calculated and used to assess the performance of DNN 400. The loss value indicates how well DNN 400 is trained. Note that a higher loss value means DNN 400 is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train DNN 400. In any case, once the loss is reduced to a very small number (ideally close to 0), DNN 400 is sufficiently trained for prediction. Prediction of the model (e.g., DNN 400) can be achieved by passing the independent variables of test data (i.e., for comparing train vs. test) or the real values that need to be predicted to predict a database for a particular set of requirements.

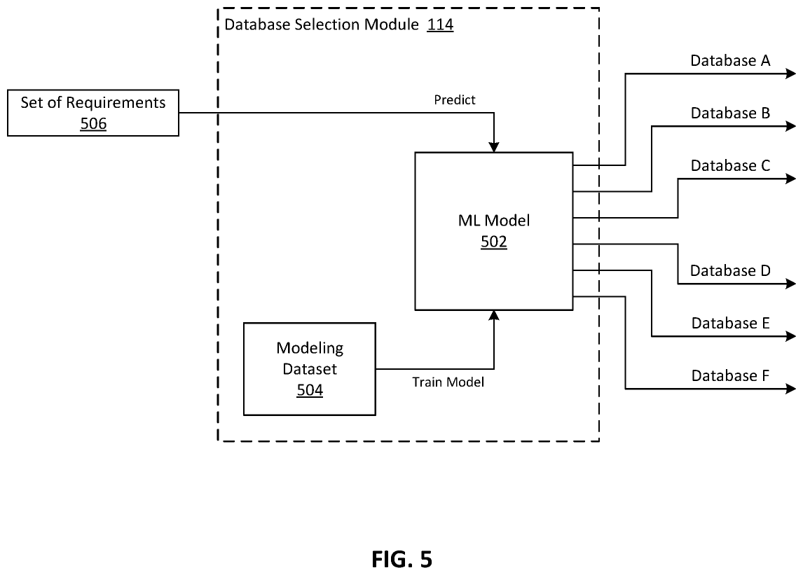

Referring now to FIG. 5, in which like elements of FIG. 1B are shown using like reference designators, shown is a diagram of an example topology that can be used to predict a database for a particular set of requirements, in accordance with an embodiment of the present disclosure. As shown in FIG. 5, database selection module 114 includes a machine learning (ML) model 502. As described previously, according to one embodiment, ML model 502 can be a multiclass classification model (e.g., an MLP or an ANN). ML model 502 can be trained and tested/validated using machine learning techniques with a modeling dataset 504. Modeling dataset 504 can be retrieved from a data repository (e.g., data repository 112 of FIG. 1B). As described previously, modeling dataset 504 for ML model 502 may be generated from the collected corpus of the organization's historical database transaction metadata and the database attribute metadata. Once ML model 502 is sufficiently trained, database selection module 110 can, in response to receiving a set of requirements of a database, predict a database that is optimal for the input set of requirements. For example, as shown in FIG. 5, a feature vector 506 that represents a set of requirements for a database, such as some or all the variables that may influence the prediction of a database, may be determined and input, passed, or otherwise provided to the trained ML model 502. In some embodiments, the input feature vector 506 (e.g., the feature vector representing the set of requirements) may include some or all the relevant features which were used in training ML model 502. The trained ML model 502 can then predict a database for the set of requirements represented by feature vector 506. In the example of FIG. 5, the predicted may be Database A, Database B, Database C, Database D, Database E, or Database F. For example, Database A, Database B, Database C, Database D, Database E, and Database F may be the databases utilized by the organization and for which ML model 502 is trained for prediction.

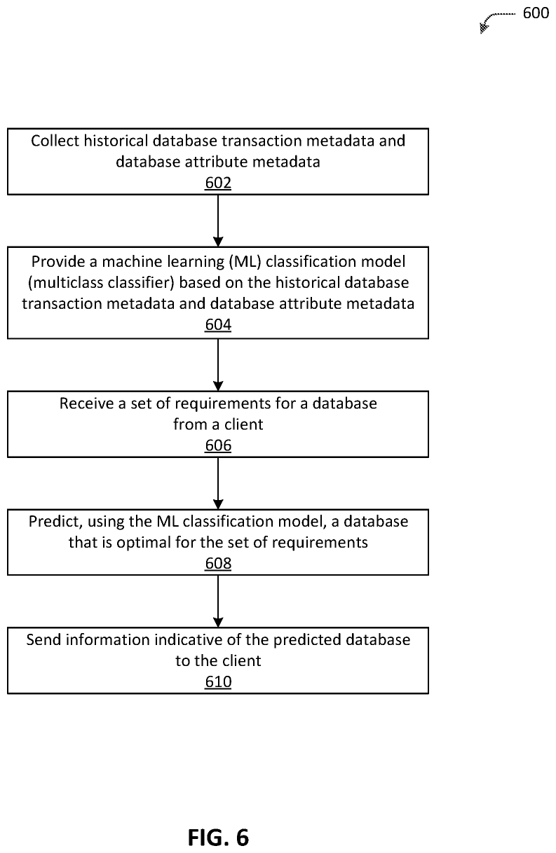

FIG. 6 is a flow diagram of an example process 600 for recommending a database for a particular set of requirements, in accordance with an embodiment of the present disclosure. Process 600 may be implemented or performed by any suitable hardware, or combination of hardware and software, including without limitation the components of network environment 100 shown and described with respect to FIGS. 1A and 1B, the computing device shown and described with respect to FIG. 7, or a combination thereof. For example, in some embodiments, the operations, functions, or actions illustrated in process 600 may be performed, for example, in whole or in part by data collection module 110 and database selection module 114, or any combination of these including other components of database selection service 108 described with respect to FIGS. 1A and 1B.

With reference to process 600 of FIG. 6, at 602, historical database transaction metadata and database attribute metadata may be collected. The collected historical database transaction metadata and database attribute metadata can be used to generate a modeling dataset for use in training and testing/validating a ML multiclass classification model to predict a database for a particular set of requirements. For example, data collection module 110 may collect the historical database transaction metadata and database attribute metadata from various data management system utilized by the organization and/or from other data sources used by the organization to store or otherwise maintain such data.

At 604, a ML multiclass classification model may be trained or configured using the modeling dataset generated from some or all of the collected historical database transaction metadata and database attribute metadata. For example, a MLP, an ANN, or other suitable deep learning algorithm may be trained and tested/validated using the modeling dataset to build the ML multiclass classification model. For example, in one implementation, database selection module 114 may train the ML multiclass classification model. The trained ML multiclass classification model can, in response to receiving a set of requirements of a database, predict a database that is optimal for the input set of requirements.

At 606, a set of requirements for a database may be received. For example, the set of requirements may be received along with a request for a database recommendation from a client (e.g., client device 102 of FIG. 1A). In response to the set of requirements for a database being received, at 608, a database that is optimal for the set of requirements may be predicted. For example, database selection module 114 may generate a feature vector that represents the set of requirements. Database selection module 114 can then input the generated feature vector to the ML multiclass classification model, which outputs a prediction of a database that is optimal for the set of requirements.

At 610, information indicative of the predicted database may be sent or otherwise provided to the client and presented to a user such as the user who sent the request for the database recommendation. For example, the information indicative of the predicted database may be presented within a user interface of a client application on the client.

FIG. 7 is a block diagram illustrating selective components of an example computing device 700 in which various aspects of the disclosure may be implemented, in accordance with an embodiment of the present disclosure. As shown, computing device 700 includes one or more processors 702, a volatile memory 704 (e.g., random access memory (RAM)), a non-volatile memory 706, a user interface (UI) 708, one or more communications interfaces 710, and a communications bus 712.

Non-volatile memory 706 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 708 may include a graphical user interface (GUI) 714 (e.g., a touchscreen, a display, etc.) and one or more input/output (I/O) devices 716 (e.g., a mouse, a keyboard, a microphone, one or more speakers, one or more cameras, one or more biometric scanners, one or more environmental sensors, and one or more accelerometers, etc.).

Non-volatile memory 706 stores an operating system 718, one or more applications 720, and data 722 such that, for example, computer instructions of operating system 718 and/or applications 720 are executed by processor(s) 702 out of volatile memory 704. In one example, computer instructions of operating system 718 and/or applications 720 are executed by processor(s) 702 out of volatile memory 704 to perform all or part of the processes described herein (e.g., processes illustrated and described in reference to FIGS. 1 through 6). In some embodiments, volatile memory 704 may include one or more types of RAM and/or a cache memory that may offer a faster response time than a main memory. Data may be entered using an input device of GUI 714 or received from I/O device(s) 716. Various elements of computing device 700 may communicate via communications bus 712.

The illustrated computing device 700 is shown merely as an illustrative client device or server and may be implemented by any computing or processing environment with any type of machine or set of machines that may have suitable hardware and/or software capable of operating as described herein.

Processor(s) 702 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 702 may be analog, digital or mixed signal. In some embodiments, processor 702 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 710 may include one or more interfaces to enable computing device 700 to access a computer network such as a Local Area Network (LAN), a Wide Area Network (WAN), a Personal Area Network (PAN), or the Internet through a variety of wired and/or wireless connections, including cellular connections.

In described embodiments, computing device 700 may execute an application on behalf of a user of a client device. For example, computing device 700 may execute one or more virtual machines managed by a hypervisor. Each virtual machine may provide an execution session within which applications execute on behalf of a user or a client device, such as a hosted desktop session. Computing device 700 may also execute a terminal services session to provide a hosted desktop environment. Computing device 700 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, a set of requirements for a database;
generating, by the computing device, a feature vector representative of the set of requirements for the database;
predicting, by the computing device using a machine learning (ML) model, a database for the set of requirements based on the feature vector; and
sending, by the computing device, information indicative of the predicted database to a client.

2. The method of claim 1, wherein the ML model includes a multiclass classification model.

3. The method of claim 1, wherein the ML model is trained using a modeling dataset generated from a corpus of historical database transaction metadata and database attribute metadata of an organization.

4. The method of claim 3, wherein the corpus of database attribute metadata includes information indicative of types of databases utilized by the organization.

5. The method of claim 3, wherein the corpus of database attribute metadata includes information indicative of features provided by databases utilized by the organization.

6. The method of claim 3, wherein the corpus of database attribute metadata includes information indicative of availability provided by databases utilized by the organization.

7. The method of claim 3, wherein the corpus of database attribute metadata includes information indicative of transaction level capabilities of databases utilized by the organization.

8. The method of claim 3, wherein the corpus of database attribute metadata includes information indicative of security and access control capabilities of databases utilized by the organization.

9. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving a set of requirements for a database;
generating a feature vector representative of the set of requirements for the database;
predicting, using a machine learning (ML) model, a database for the set of requirements based on the feature vector; and
sending information indicative of the predicted database to a client.

10. The system of claim 9, wherein the ML model includes a multiclass classification model.

11. The system of claim 9, wherein the ML model is trained using a modeling dataset generated from a corpus of historical database transaction metadata and database attribute metadata of an organization.

12. The system of claim 11, wherein the corpus of database attribute metadata includes information indicative of types of databases utilized by the organization.

13. The system of claim 11, wherein the corpus of database attribute metadata includes information indicative of features provided by databases utilized by the organization.

14. The system of claim 11, wherein the corpus of database attribute metadata includes information indicative of availability provided by databases utilized by the organization.

15. The system of claim 11, wherein the corpus of database attribute metadata includes information indicative of transaction level capabilities of databases utilized by the organization.

16. The system of claim 11, wherein the corpus of database attribute metadata includes information indicative of security and access control capabilities of databases utilized by the organization.

17. The system of claim 11, wherein the corpus of database transaction metadata includes information indicative of database transactions of the organization and corresponding performance metrics.

18. A non-transitory machine-readable medium encoding instructions that when executed by one or more processors cause a process to be carried out, the process including:
receiving a set of requirements for a database;
generating a feature vector representative of the set of requirements for the database;
predicting, using a machine learning (ML) multiclass classification model, a database for the set of requirements based on the feature vector; and
sending information indicative of the predicted database to a client.

19. The machine-readable medium of claim 17, wherein the ML multiclass classification model is trained using a modeling dataset generated from a corpus of database attribute metadata of an organization, wherein the database attribute metadata includes information indicative of one or more of types of databases utilized by the organization, features provided by databases utilized by the organization, availability provided by databases utilized by the organization, transaction level capabilities of databases utilized by the organization, and security and access control capabilities of databases utilized by the organization.

20. The machine-readable medium of claim 17, wherein the ML multiclass classification model is trained using a modeling dataset generated from a corpus of historical database transaction metadata of an organization, wherein the database transaction metadata includes information indicative of database transactions and corresponding performance metrics.
